(19) United States
(12) Patent Application Publication
(10) Pub. No.: US 2025/0329259 A1
(43) Pub. Date: Oct. 23, 2025

(54) NAVIGATION SERVER, NAVIGATION TERMINALS AND NAVIGATION SYSTEM

(71) Applicants: HYUNDAI MOTOR COMPANY, Seoul (KR); KIA CORPORATION, Seoul (KR)

(72) Inventor: Seong Un KIM, Anyang-si (KR)

(21) Appl. No.: 18/888,512

(22) Filed: Sep. 18, 2024

(30) Foreign Application Priority Data
Apr. 19, 2024 (KR) 10-2024-0052938

(51) Int. Cl. G08G 1/00; G01C 21/36; G08G 1/01; H04W 4/44

(52) U.S. Cl. CPC G08G 1/20; G01C 21/367; G08G 1/0112; H04W 4/44

(57) ABSTRACT

A navigation terminal for sharing a location of a vehicle includes a positioning information acquiring unit acquiring positioning information about a mounted vehicle; a data transmitting and receiving unit uploading vehicle information about the mounted vehicle to a navigation server at an update cycle, and receiving sharing vehicle information from the server to update the sharing vehicle information; a location predicting unit predicting a location for each of the sharing vehicles based on the sharing vehicle information including a speed constant at any point between a pre-update time and a post-update time related to the update cycle; and a display unit reflecting the predicted location and displaying an electronic map including the locations of the sharing vehicles in real time.

### CROSS-REFERENCE TO RELATED APPLICATION(S)

This application claims benefit of priority to Korean Patent Application No. 10-2024-0052938 filed on Apr. 19, 2024, in the Korean Intellectual Property Office, the disclosure of which is incorporated herein by reference in its entirety.

### TECHNICAL FIELD

The present disclosure relates to a navigation server, a navigation terminal, and a navigation system for improving reliability of f travelling information by distance when sharing locations between vehicles.

### BACKGROUND

In general, a navigation terminal can display a map view of a vehicle while transmitting and receiving vehicle information from a navigation server.

During navigation guidance, travelling to a destination is possible by transmitting and receiving vehicle information from other vehicles using a location sharing service. The shared location is updated at regular intervals, and this updated information is displayed simultaneously on multiple vehicles within the navigation system. This allows a driver to determine the location of other vehicles in real time, enabling group driving or sharing arrival information through the shared of the their vehicle.

In conventional navigation systems, the location sharing service works effectively when vehicles are driving at a certain distance from each other. However, when vehicles are within close proximity, there is a problem where the current locations of preceding and following vehicles may be reversed due to update cycles and errors, or the accuracy of real-time location display may be reduced.

Navigation information, such as location information of each vehicle, can be uploaded to the server through various communication networks, including navigation applications or connected car services. This information is then received from the shared vehicles and reflected in the display information.

However, the existing method of displaying navigation information updates data at regular intervals, leading to delays in reflecting real-time information on the display. To address this, setting the update cycle to a shorter interval could improve real-time accuracy, but this approach may increase the overall server load due to the more frequent updates.

### SUMMARY

The present disclosure is directed to a navigation server, a navigation terminal, and a navigation system that can predict locations of sharing vehicles according to a relative distance of the sharing vehicles during an update cycle of sharing vehicle information when sharing locations between vehicles.

According to an aspect of the present disclosure, a navigation server for sharing a location of a vehicle can include: a data receiving unit receiving and collecting relative sharing vehicle information about sharing vehicles belonging to a preset sharing group from a navigation terminal; a speed constant estimating unit estimating a speed constant for predicting a relative distance for each vehicle based on the sharing vehicle information; and a data transmitting unit providing sharing vehicle information including the speed constant, positioning information, and speed information to the navigation terminal.

According to an aspect of the present disclosure, the data receiving unit is configured to include a data collection unit receiving and collecting the sharing vehicle information at a predetermined collection cycle; and a collection cycle determining unit determining a collection cycle for each vehicle based on a relative distance between sharing vehicles included in the sharing vehicle information collected by the data collection unit.

According to an aspect of the present disclosure, the speed constant estimating unit is configured to include a relative distance determination unit determining a relative distance of each vehicle to other sharing vehicles according to a reference distance based on the sharing vehicle information; and an estimating unit estimating the speed constant using a speed estimation model based on the determined relative distance and location information.

According to an aspect of the present disclosure, the speed constant estimation model of the data receiving unit is configured to estimate the speed constant using at least one of the positioning information, speed information, travelling direction information, traffic information on a route, and the collection cycle information, and the relative distance.

According to an aspect of the present disclosure, a navigation terminal for sharing a location of a vehicle can include: a positioning information acquiring unit acquiring positioning information about a mounted vehicle; a data transmitting and receiving unit uploading vehicle information about the mounted vehicle to a navigation server at an update cycle and receiving sharing vehicle information from the server to update the sharing vehicle information; a location predicting unit predicting a location of each of the sharing vehicles based on the sharing vehicle information including a speed constant at any point between a pre-update time and a post-update time related to the update cycle; and a display unit reflecting the predicted location and displaying an electronic map including the locations of the sharing vehicles in real time.

According to an aspect of the present disclosure, the location predicting unit is configured to include a relative distance predicting unit predicting a relative distance for each of the sharing vehicles based on the sharing vehicle information, at any point between a pre-update time and a post-update time related to the update cycle; and a location calculating unit calculating the locations of the sharing vehicles based on the relative distance and the location of the mounted vehicle.

According to an aspect of the present disclosure, the location predicting unit is configured to include a required time calculating unit calculating a time required for transmission and reception based on an upload time stamp and a download time stamp for the positioning information included in the sharing vehicle information; a relative distance predicting unit predicting a relative distance for each of the sharing vehicles using the time required for transmission and reception and the sharing vehicle information; and a location calculating unit calculating the locations of the sharing vehicles based on the relative distance and the location of the mounted vehicle.

According to an aspect of the present disclosure, the data transmitting and receiving unit is configured to include a data receiving unit receiving the sharing vehicle information; an update cycle determining unit determining an update cycle based on a collection cycle included in the sharing vehicle information; and a data transmitting unit transmitting vehicle information including the update cycle to a navigation server.

According to an aspect of the present disclosure, the data transmitting and receiving unit is configured to further include an event determination unit providing an event occurrence signal to the data transmitting unit to transmit event occurrence information to the server regardless of the update cycle, when a travelling speed change of the mounted vehicle exceeds a reference speed change by comparing the travelling speed change of the mounted vehicle with the reference speed change.

According to an aspect of the present disclosure, the update cycle determining unit is configured to vary the update cycle according to a map zoom level of the mounted vehicle.

According to an aspect of the present disclosure, a navigation system for sharing a location of a vehicle can include: a navigation server collecting relative sharing vehicle information about sharing vehicles belonging a preset sharing group, estimating a speed constant for predicting a relative distance for each vehicle based on the sharing vehicle information, and providing sharing vehicle information including the speed constant, positioning information, and speed information; and a navigation terminal receiving sharing vehicle information from the navigation server at a preset update cycle to update the sharing vehicle information, and predicting a location of each of the sharing vehicles and displaying the location thereof in real time, during a pre-update time and a post-update time related to the update cycle using the speed constant, positioning information, and speed information included in the sharing vehicle information.

According to an aspect of the present disclosure, the navigation server is configured to include a data collection unit receiving and collecting the sharing vehicle information from each vehicle at a predetermined collection cycle; and a collection cycle determining unit determining a collection cycle for each vehicle based on a relative distance between sharing vehicles included in the sharing vehicle information collected by the data collection unit.

According to an aspect of the present disclosure, the navigation server is configured to include a speed constant estimating unit, wherein the speed constant estimating unit includes a relative distance determination unit determining a relative distance to sharing vehicles based on each vehicle based on the sharing vehicle information according to a reference distance; and an estimating unit estimating the speed constant using a speed constant estimation model based on the determined relative distance and location information. According to an aspect of the present disclosure, the speed constant estimation model of the data receiving unit is configured to estimate the speed constant using at least one of the positioning information, speed information, travelling direction information, traffic information on a route, and the collection cycle information included in the sharing vehicle information, and the relative distance.

According to an aspect of the present disclosure, the navigation terminal is configured to include a positioning information acquiring unit acquiring positioning information for a mounted vehicle; a data transmitting and receiving unit uploading vehicle information about the mounted vehicle to a navigation server at an update cycle, and receiving sharing vehicle information from the server to update the sharing vehicle information; a location predicting unit predicting a location of each of the sharing vehicles, at any point between a pre-update time and a post-update time related to the update cycle, based on the sharing vehicle information including a speed constant; and a display unit reflecting the predicted location and displaying an electronic map including the locations the sharing vehicles in real time.

According to an aspect of the present disclosure, the location predicting unit is configured to include a relative distance predicting unit predicting a relative distance for each of the sharing vehicles based on the sharing vehicle information, at any point between a pre-update time and a post-update time related to the update cycle; and a location calculating unit calculating the locations of the sharing vehicles based on the relative distance and the location of the mounted vehicle.

According to an aspect of the present disclosure, the location predicting unit is configured to include a required time calculating unit calculating a time required for transmission and reception based on an upload time stamp and for the positioning information a download time stamp included in the sharing vehicle information; a relative distance predicting unit predicting a relative distance of each of the sharing vehicles using the time required for transmission and reception and the sharing vehicle information; and a location calculating unit calculating the locations of the sharing vehicles based on the relative distance and the location of the mounted vehicle.

According to an aspect of the present disclosure, the data transmitting and receiving unit is configured to include a data receiving unit receiving the sharing vehicle information; an update cycle determining unit determining an update cycle based on a collection cycle included in the sharing vehicle information; and a data transmitting unit transmitting vehicle information including the update cycle to a navigation server.

According to an aspect of the present disclosure, the data transmitting and receiving unit is configured to further include an event determination unit providing an event occurrence signal to a data transmitting unit to transmit event occurrence information to the server regardless of the update cycle, when a travelling speed change of the mounted change exceeds a reference speed change by comparing the traveling speed change of the mounted vehicle with the reference speed change.

According to an aspect of the present disclosure, the update cycle determining unit is configured to vary the update cycle according to the map zoom level of the mounted vehicle.

### BRIEF DESCRIPTION OF DRAWINGS

FIG. 1 is a schematic diagram illustrating an example of a navigation system.

FIG. 2 is an exemplary diagram of a navigation server.

FIG. 3 is a diagram illustrating an example of an operation of a navigation server.

FIG. 4 is an exemplary diagram of a data receiving unit.

FIG. 5 is an exemplary diagram of a speed constant estimating unit.

FIG. 6 is an exemplary diagram of a speed constant estimation model of a speed constant estimating unit.

FIG. 7 is an exemplary diagram of a speed constant estimation model.

FIG. 8 is an exemplary diagram of a navigation terminal.

FIG. 9 is a diagram illustrating an example of an operation of a navigation terminal.

FIG. 10 is an exemplary diagram of a location predicting unit.

FIG. 11 is a diagram illustrating an example of an operation of a location predicting unit.

FIG. 12 is another exemplary diagram of a location predicting unit.

FIG. 13 is an exemplary diagram of a data transmitting and receiving unit.

FIG. 14 is another exemplary diagram of a data transmitting and receiving unit.

FIG. 15 is an exemplary diagram of an update cycle determining unit.

FIG. 16 is a block diagram of an example of a computing device 1000 that can fully or partially implement a navigation server and a navigation terminal.

### DETAILED DESCRIPTION

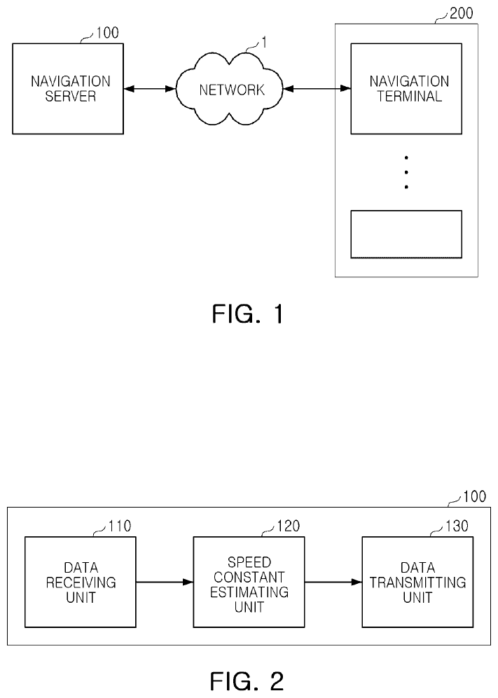

FIG. 1 is a schematic diagram of a navigation system.

Referring to FIG. 1, the navigation system can include a navigation server 100 and a navigation terminal 200 connected to a network 1.

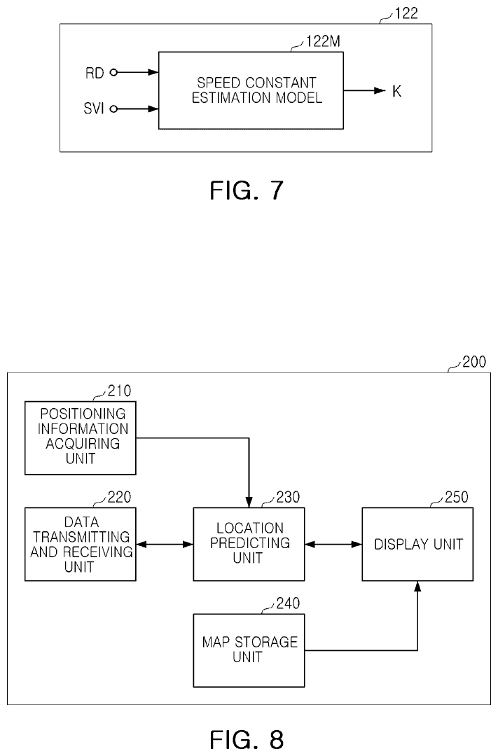

The navigation server 100 may collect relative sharing vehicle information about sharing vehicles belonging to a preset sharing group, estimate a speed constant K for predicting a relative distance for each vehicle based on the sharing vehicle information, and provide sharing vehicle information including the speed constant K, positioning information, and speed information. This will be described with reference to FIGS. 2 and 7.

The navigation terminal 200 may receive sharing vehicle information from the server 100 at a preset update cycle to update the sharing vehicle information, and predict a location of each of the sharing vehicles using the speed constant K, positioning information, and speed information included in the sharing vehicle information, during a pre-update time and a post-update time related to the update cycle to display the location thereof in real time. This will be described with reference to FIGS. 8 to 15.

For each drawing of the present disclosure, unnecessary redundant descriptions of components with the same symbols and the same function may be omitted, and possible differences between the drawings may be explained.

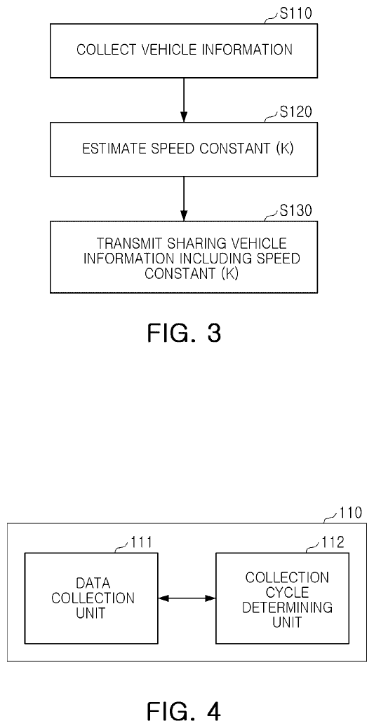

FIG. 2 is an exemplary diagram of a navigation server, and FIG. 3 is a diagram illustrating an operation of the navigation server.

Referring to FIGS. 2 and 3, the navigation server 100 may include a data receiving unit 110, a speed constant estimating unit 120, and a data transmitting unit 130.

The data receiving unit 110 may receive and collect sharing vehicle information about sharing vehicles belonging to a preset sharing group (S120 in FIG. 3). For example, there may be two or more sharing vehicles belonging to the sharing group. The sharing vehicle information for each of the sharing vehicles belonging to the sharing group may be collected at a preset collection cycle.

The speed constant estimating unit 120 may estimate a speed constant (K) for predicting a relative distance for each vehicle among the sharing vehicles belonging to the sharing group based on the sharing vehicle information (S120 in FIG. 3).

The data transmitting unit 130 may provide sharing vehicle information including the speed constant K, positioning information, and speed information (S130 in FIG. 3). For example, the positioning information may be information obtained through a GNSS satellite system. As an example, the GNSS satellite system may be a Global Positioning System (GPS).

In the present disclosure, each of the data receiving unit 110, the speed constant estimating unit 120, and the data transmitting unit 130 may be implemented as an individual processor, or all the data receiving unit 110, the speed constant estimating unit 120, and the data transmitting unit 130 may be implemented with one processor, and is not particularly limited to any one thereof.

In addition, each of the data receiving unit 110, the speed constant estimating unit 120, and the data transmitting unit 130 may be implemented as hardware or software in at least one integrated circuit IC built into the navigation server 100, and is not particularly limited to any one thereof.

FIG. 4 is an exemplary diagram of a data receiving unit.

Referring to FIG. 4, the data receiving unit 110 may include a data collection unit 111 and a collection cycle determination unit 112.

The data collection unit 111 may receive and collect the sharing vehicle information from each vehicle among the sharing vehicles belonging to a sharing group at a predetermined collection cycle. For example, the data collection unit 111 may store sharing vehicle information for each of the sharing vehicles in an internal memory for each vehicle.

The collection cycle determining unit 112 may determine a collection cycle for each vehicle based on a relative distance between sharing vehicles included in the sharing vehicle information collected by the data collection unit 111. For example, the relative distance is a distance between each vehicle and other vehicles among the sharing vehicles, and this may be information included in the sharing vehicle information collected from each vehicle included in the sharing vehicles.

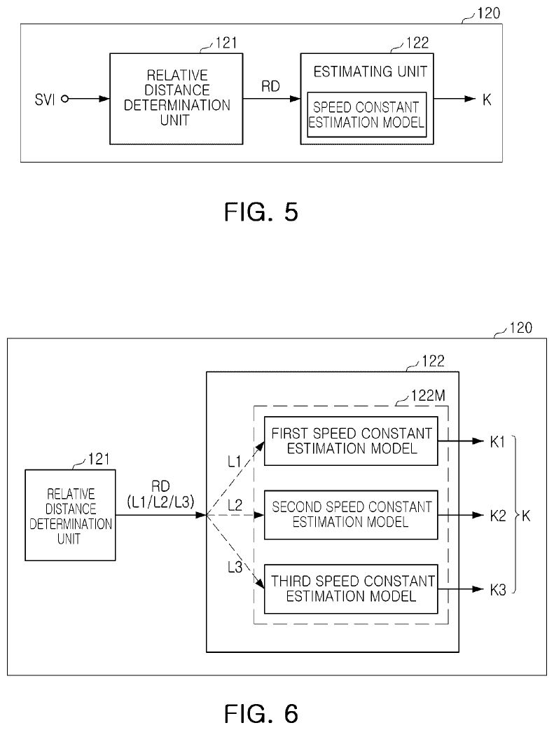

FIG. 5 is an exemplary diagram of a speed constant estimating unit.

Referring to FIG. 5, the speed constant estimating unit 120 may include a relative distance determination unit 121 and an estimating unit 122.

The relative distance determination unit 121 may determine the relative distance RD to other sharing vehicles for each vehicle based on the sharing vehicle information (SVI) according to a reference distance. For example, the reference distance may include a short-distance reference distance and a long-distance reference distance. Accordingly, when the relative distance is less than the short-distance standard distance, it can be identified as a short-distance, when the relative distance is more than the short-distance standard distance and less than the long-distance standard distance, it can be identified as a medium-distance, and when the relative distance is more than the long-distance standard distance, it can be identified as a long-distance.

The estimating unit 122 may estimate the speed constant (K) using the speed constant estimation model 122M based on the determined relative distance (RD) and location information. For example, among sharing vehicles, the speed constant (K) for each vehicle may determine whether the speed constant (K) is forwards or backwards with respect to a travelling direction based on location information, and estimate the same as different values according to the short, medium, and long distances based on the relative distance (RD).

FIG. 6 is an exemplary diagram of a speed constant estimation model of a speed constant estimating unit.

Referring to FIG. 6, the relative distance determination unit 121 may determine the relative distance to sharing vehicles for each vehicle (e.g., mounted vehicle) based on the sharing vehicle information (SVI) as a reference distance, for example, according to short-distance standards, medium-distance standards, and long-distance standards. Accordingly, relative distances to sharing vehicles may be distinguished into a short distance (L1), a medium distance (L2), and a long distance (L3) based on the mounted vehicle.

For example, the speed constant estimation model 122M of the estimating unit 122 may include a first speed constant estimation model, a second speed constant estimation model, and a third speed constant estimation model. As an example, the first speed constant estimation model may operate when the distinguished relative distance RD is a short distance to estimate a short-range speed constant (K1). The second speed constant estimation model may operate when the distinguished relative distance RD is a medium-distance to estimate a medium-distance speed constant (K2). The third speed constant estimation model may operate when the distinguished relative distance RD is a long-distance to estimate a long-distance speed constant (K3).

FIG. 7 is an exemplary diagram of a speed constant estimation model.

Referring to FIG. 7, a speed constant estimation model 122M of the data receiving unit 110 may estimate the speed constant (K) using at least one of the positing information PI, speed information VI, travelling direction information DI, traffic information on a route TI, and the collection cycle information CCI, and the relative distance RD. For example, when using two or more pieces of information among location information PI, speed information VI, travelling direction information DI, traffic information on the route TI, a relatively accurate speed constant may be estimated depending on the speed constant estimation model.

As illustrated with reference to FIGS. 1 to 7, the navigation server 100 may estimate a speed constant (K) for predicting a relative distance for each of sharing vehicles based on the collected sharing vehicle information to be included in the sharing vehicle information, and provide the same to a navigation terminal. Hereinafter, the navigation terminal 200 will be described with reference to FIGS. 8 to 15.

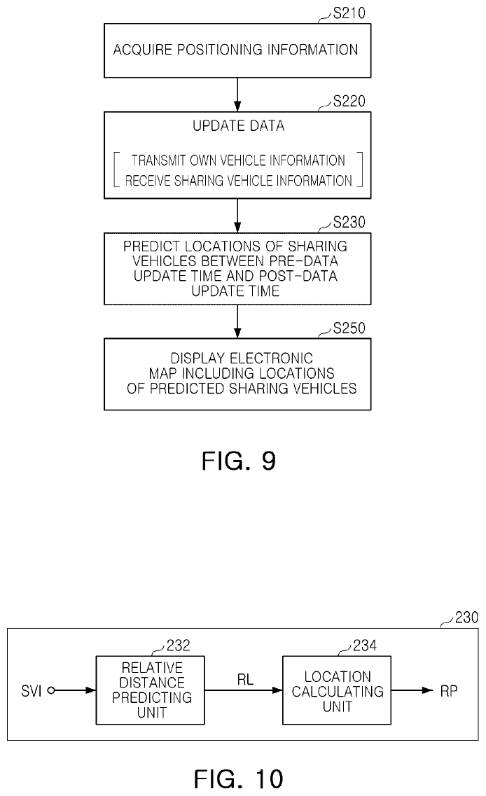

FIG. 8 is an exemplary diagram of a navigation terminal, and FIG. 9 is a diagram illustrating an operation of the navigation terminal.

Referring to FIGS. 8 and 9, a navigation terminal 200 may include a positioning information acquiring unit 210, a data transmitting and receiving unit 220, a location predicting unit 230, a map storage unit 240, and a display unit 250.

The positioning information acquiring unit 210 may acquire positioning information for the mounted vehicle 10 (see FIG. 11) (S210 in FIG. 9). For example, the mounted vehicle may be a vehicle having the currently described navigation terminal among a plurality of sharing vehicles belonging to a sharing group mounted thereon, and may be a reference vehicle for a relative distance of this mounted vehicle. As an example, the positioning information may be location information measured using a plurality of positioning satellites, and may be acquired through the above-described GNSS satellite system or Global Positioning System (GPS).

The data transmitting and receiving unit 220 may upload vehicle information about the mounted vehicle 10 (see FIG. 11) to a navigation server 100 at an update cycle UC, and receive sharing vehicle information (SVI) from the server 100 to update the sharing vehicle information (S220 in FIG. 9). For example, the update cycle UC may be synchronized with a collection cycle CC of the navigation server 100 through communication between the navigation server 100 and the navigation terminal 200. This is an example and is not limited thereto.

The location predicting unit 230, based on the sharing vehicle information (SVI) including a speed constant (K), may predict the location of each of the sharing vehicles, at any point (T15) between a pre-update time (T10) and a post-update time (T20) related to the update cycle UC (S230 in FIG. 9). For example, by using the relative distance to other sharing vehicles based on the mounted vehicle, the location of each of the other sharing vehicles may be determined based on the location of the mounted vehicle and the relative distances to the other sharing vehicles.

As described above, when using a location sharing service in a navigation terminal, while sharing locations between multiple vehicles, the update cycle and location prediction are actively performed according to a distance between sharing vehicles, the location thereof in real-time may be updated without affecting an actual navigation server and wireless network communication load, thereby increasing the reliability of travelling location information, and providing more real-time display information to a driver.

The map storage unit 240 may include an electronic map. For example, the electronic map may be a map DB, and this map DB can store nationwide map data in numerical form, and in particular, the map DB may be an electronic map or a digital map including information related to traffic information, road information, and map information, updated periodically or in real time.

The display unit 250 may reflect the predicted locations (S250 in FIG. 9) to display an electronic map including the locations of the sharing vehicles C1, C2, C3 . . . in real time. For example, the display unit 250 may display the locations of sharing vehicles, and may be a touchscreen capable of touch input. As an example, the display unit 250 may be a touchscreen of an infotainment provided in a vehicle or a touchscreen of a smart phone.

The navigation terminal 200 may be implemented in a mobile device such as an infotainment terminal or a smartphone.

In the present disclosure, each of the positioning information acquiring unit 210, the data transmitting and receiving unit 220, the location predicting unit 230, and the map storage unit 240 may be implemented as an individual processor, or all the positioning information acquiring unit 210, the data transmitting and receiving unit 220, the location predicting unit 230, and the map storage unit 240 may be implemented with one processor, and is not particularly limited to any one thereof.

In addition, each of the positioning information acquiring unit 210, the data transmitting and receiving unit 220, the location predicting unit 230, and the map storage unit 240 may be implemented as a hardware or software in at least one integrated circuit IC built into the navigation terminal 200, and is not particularly limited to any one thereof.

FIG. 10 is an exemplary diagram of a location prediction unit.

Referring to FIG. 10, the location predicting unit 230 may include a relative distance predicting unit 232 and a location calculating unit 234.

The relative distance predicting unit 232, at any point (T15 in FIG. 11) between a pre-update time (T10) and a post-update time (T20) related to the update cycle UC, may predict a relative distance RL for each of the sharing vehicles based on the sharing vehicle information SVI. For example, based on the positioning information about the mounted vehicle among the sharing vehicles, the relative distance to each of the other sharing vehicles may be predicted using the location information and speed information included in the sharing vehicle information SVI. The location calculating unit 234 may calculate the locations of the sharing vehicles based on the relative distance RL and the location of the mounted vehicle 10 (see FIG. 11). For example, the relative distance to other sharing vehicles in a travelling direction is known based on the location of the mounted vehicle, the location of the corresponding vehicle may be determined.

Since there is a certain time interval between a pre-update time (T10) and a post-update time (T20) within the update cycle UC, when the vehicle is travelling at a high speed, there may be a difference in locations to some extent, between the location of the vehicle at the pre-update time (T10) and the location of the vehicle at the post-update time (T20). Accordingly, for each of sharing vehicles, when the locations between the two update times may be displayed in more detail.

FIG. 11 is a diagram illustrating an operation of a position prediction unit.

Referring to FIG. 11, for example, among the sharing vehicles, a preceding vehicle C1 and a following vehicle C2 of the mounted vehicle (MC) 10, and a parallel vehicle C3 running side by side in a next lane are included, the locations of each of the preceding vehicle C1, the following vehicle C2, and the parallel vehicle C3 in the next lane, may be predicted.

Accordingly, as illustrated in FIG. 11, the location of each of sharing vehicles may be displayed at any time (T15 in FIG. 11) between the pre-update time T10 and the post-update time T20.

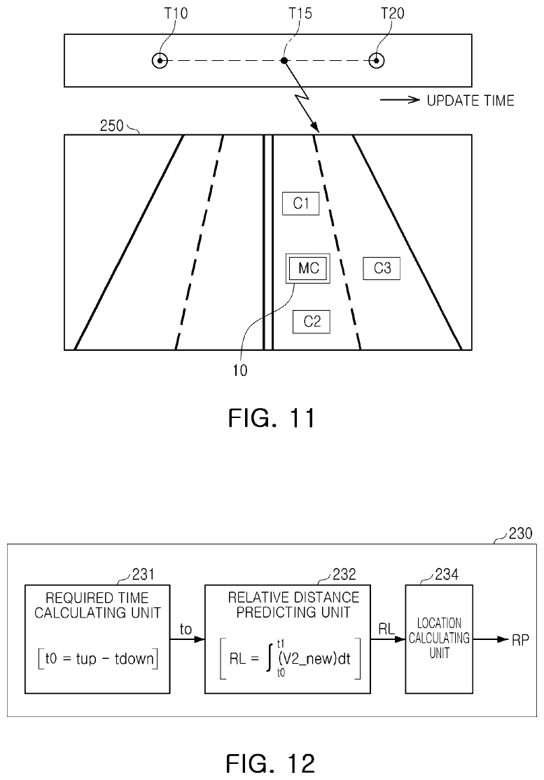

FIG. 12 is another exemplary diagram of a location predicting unit.

Referring to FIG. 12, the location predicting unit 230 may include a required time calculating unit 231, a relative distance predicting unit 232, and a location calculating unit 234.

The required time calculating unit 231 can calculate a time required for transmission and reception (t0) based on an upload time stamp (Tup) and a download time stamp (Tdown) for positioning information (PI) included in the sharing vehicle information (SVI). For example, the time required for transmission and reception (t0) may be information on a time difference for uploading and downloading to the navigation server 100, that is, transmitting and receiving, and this time required for transmission and reception can be reflected in predicting a relative distance, and the time required for transmission and reception (t0) may be obtained as shown in Equation 1 below.

t0=tup−tdown [Equation 1]

The relative distance predicting unit 232 may predict a relative distance (RL) for each of the sharing vehicles using the time required for transmission and reception (t0) and the sharing vehicle information (SVI). For example, the relative distance (RL) can be obtained according to Equation 2 below.

$$R L = {\int }_{t 0}^{t 1} ( V2\_new ) dt \qquad [ Equation 2 ]$$

$$V2\_new = V 2 + K * ( V 1 - V 2 ) * dt$$

In Equation 2 above, V1 is a speed of a preceding vehicle, V2 is a speed of a following vehicle, t1 is a data update cycle, t0 is a time required for transmission and reception between a navigation terminal and a server, and K is a speed constant. Here, K may vary depending on a location and speed between vehicles.

The location calculating unit 234 may calculate the locations of the sharing vehicles based on the relative distance (RL) and the location of the vehicle 10. For example, by addition calculating a distance relative to the location of the vehicle 10, the location of the vehicle can be determined. Since the above addition calculation is merely an example, it is not limited thereto.

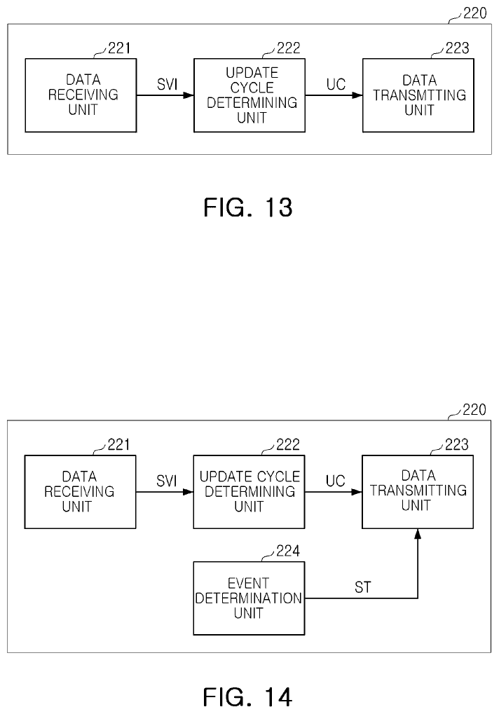

FIG. 13 is an exemplary diagram of a data transmitting and receiving unit.

Referring to FIG. 13, the data transmitting and receiving unit 220 may include a data receiving unit 221, an update cycle determining unit 222, and a data transmitting unit 223.

The data receiving unit 221 may receive the sharing vehicle information SVI from the navigation server 100. For example, the data receiving unit 221 may receive vehicle information for each shared vehicle belonging to the sharing group, that is, sharing vehicle information, from the navigation server 100 according to a predetermined update cycle UC.

The update cycle determining unit 222 may determine an update cycle UC based on the collection cycle CC included in the sharing vehicle information SVI. For example, when information about the collection cycle set in the navigation server 100 is included in the sharing vehicle information, the update cycle determining unit 222 of the navigation terminal 200 may set an update cycle based on the collection cycle.

The data transmitting unit 223 may transmit vehicle information including the update cycle UC to the navigation server 100. For example, the navigation terminal 200 can also include update cycle information in its vehicle information and transmit the same to the navigation server 100 through the data transmitting unit 223. Accordingly, the navigation server and the navigation terminal can transmit and receive vehicle information in synchronization with each other at a predetermined time.

FIG. 14 is another exemplary diagram of a data transmitting and receiving unit.

Referring to FIG. 14, the data transmitting and receiving unit 220 may further include an event determination unit 224 in addition to the configuration illustrated in FIG. 13.

By comparing a travelling speed change (ΔV) of the mounted vehicle 10 with a reference speed change (ΔVref), when the travelling speed change (ΔV) exceeds the reference speed change (ΔVref), the event determination unit 224 may provide an event occurrence signal (ST) to the data transmitting unit to transmit event occurrence information to the navigation server 100 regardless of the update cycle UC.

For example, when the data transmitting unit 223 receives the event occurrence signal ST, the data transmitting unit 223 may immediately transmit a signal notifying the occurrence of event to the navigation server 100. Accordingly, based on the vehicle information collected in the navigation server 100, it is possible to determine whether an event has occurred for each shared vehicle.

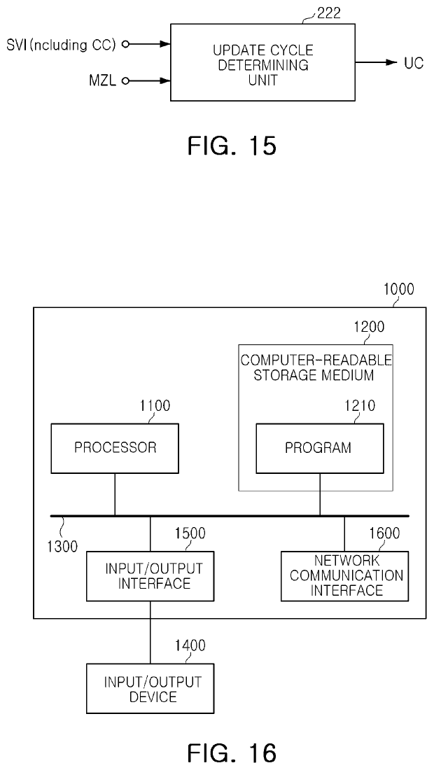

FIG. 15 is an exemplary diagram of an update cycle determining unit.

Referring to FIG. 15, the update cycle determining unit 222 may vary the update cycle UC according to a map zoom level MZL of the vehicle 10. For example, the update cycle of the navigation terminal 200 may be set based on a collection cycle CC of the navigation server 100 as described above, but unlike this, the navigation terminal 200 itself may vary the update cycle UC according to the map zoom level MZL, and for example, as the map zoom level MZL increases, the update cycle may become shorter.

As such, by variably controlling a collection cycle of vehicle information collection cycle according to the map zoom level of the actually displayed vehicle sharing location, a burden of communication load with the navigation server can be reduced.

As described above, in the present disclosure, by dividing a location between each vehicle into stages based on the vehicle information collected when sharing the location between sharing vehicles belonging to a sharing group, and predicting the location of each of the sharing vehicles even between update cycles for receiving data, information about sharing vehicles may be displayed at a more detailed cycle than the update cycle. Accordingly, the display and location confirmation of sharing vehicles may be performed more quickly.

FIG. 16 is a block diagram of an example of a computing device 1000 capable of fully or partially implementing a navigation server and a navigation terminal.

As illustrated in FIG. 16, the computing device 1000 includes at least one processor 1100, a computer-readable storage medium 1200, and a communication bus 1300.

The processor 1100 may cause the computing device 1000 to operate according to the above-described exemplary implementations. For example, the processor 1100 may execute one or more programs stored in the computer-readable storage medium 1200. The one or more programs may include one or more computer executable instructions, Wherein, when executed by the processor 1100, the computer-readable executable instructions may be configured to cause the computing device 1000 to perform operations.

The computer-readable storage medium 1200 is configured to store computer-executable instructions or program code, program data, and/or other suitable forms of information. A program 1210 stored on the computer-readable storage medium 1200 includes a set of instructions executable by the processor 1100. In some implementations, the computer-readable storage medium 1200 may include a memory (a volatile memory such as a random access memory, a non-volatile memory, or a suitable combination thereof), one or more magnetic disk storage devices, optical disk storage devices, flash memory devices, other forms of storage media that can be accessed by the computing device 1000 and store desired information, or suitable combinations thereof.

The communication bus 1300 interconnects various other components of the computing device 1000, including the processor 1100 and the computer-readable storage medium 1200. The computing device 1000 may also include one or

more input/output interfaces 1500 and one or more network communication interfaces 1600 providing an interface for one or more input/output devices 1400. The input/output interface 1500 and the network communication interface 1600 are connected to the communication bus 1300. The network may be either a cellular network, such as a global system for mobile communications (GSM), enhanced data rates for GSM evolution (EDGE), a general packet radio service (GPRS), a code division multiple access (CDMA), a time division CDMA (TD-CDMA), a universal mobile telecommunications system (UMTS), a long term evolution (LTE), or another cellular network.

The input/output device 1400 may be connected to other components of the computing device 1000 through the input/output interface 1500. The exemplary input/output device 1400 may include an input device such as a pointing device (a mouse, a trackpad, or the like), a keyboard, a touch input device (a touchpad, a touchscreen, or the like), a voice or sound input device, various types of sensor devices, and/or a photographing device, and an output device such as a display device, a printer, a speaker, and/or a network card. The exemplary input/output device 1400 may be included inside the computing device 1000 as a component constituting the computing device 1000, or may be connected to the computing device 1000 as a separate device, distinct from the computing device 1000.

Meanwhile, implementations of the present disclosure may include a program for performing the methods described in this specification on a computer, and a computer readable recording medium including the program. The computer-readable recording medium may include program instructions, local data files, local data structures, or the like, alone or in a combination thereof. The medium may be specially designed and configured for the present disclosure, or may be commonly available in the field of computer software. Examples of the computer-readable medium may include a hardware device specially configured to store a magnetic medium such as hard disks, floppy disks and magnetic tapes, an optical recording medium such as CD-ROMs and DVDs, and program instructions such as ROM, RAM, and a flash memory and perform the same. Examples of the program may include not only machine language codes generated by a compiler, but also high-level language codes that may be executed by a computer using an interpreter.

As set forth above, according to an aspect of the present disclosure, when sharing locations of vehicles, the locations of sharing vehicles may be predicted according to a relative distance to the sharing vehicles during update cycles of sharing vehicle information, and accordingly, as the locations of the sharing vehicles between update cycles are predicted without putting a load on the server, the locations of the sharing vehicles may be displayed in real time in more detail than the update cycles.

In other words, during location sharing between multiple vehicles, as the update cycle and location prediction are actively performed according to the relative distance between the sharing vehicles, the locations thereof in real time may be updated in more detail than the update cycle without affecting the actual server and communication network server, and accordingly, the reliability of travelling location information may be increased and more real-time display information can be provided to a driver.

What is claimed is:

1. A navigation server for sharing a location of a vehicle, the navigation server comprising:
a data receiver configured to receive, from a navigation terminal, relative sharing vehicle information regarding one or more vehicles associated with a preset sharing group;
a speed constant estimating unit, implemented using one or more computing devices, configured to determine a speed constant for predicting a relative distance for each vehicle based on the sharing vehicle information; and
a data transmitter configured to transmit, to the navigation terminal, sharing vehicle information including the speed constant, positioning information, and speed information.

2. The navigation server of claim 1, wherein the data receiver comprises:
a data collector configured to receive, from each vehicle at a predetermined collection cycle, the relative sharing vehicle information, and
a collection cycle determining unit, implemented using one or more computing devices, configured to determine a collection cycle for each vehicle based on a relative distance between the one or more vehicles included in the relative sharing vehicle information from the data collector.

3. The navigation server of claim 1, wherein the speed constant estimating unit comprises:
a relative distance determination unit, implemented using one or more computing devices, configured to determine a relative distance of each vehicle to other vehicles according to a reference distance based on the relative sharing vehicle information, and
an estimating unit, implemented using one or more computing devices, configured to determine the speed constant using a speed constant estimation model based on the determined relative distance and location information.

4. The navigation server of a vehicle of claim 3, wherein the speed constant estimation model is configured to determine the speed constant using (i) at least one of positioning information, speed information, travelling direction information, traffic information on a route, or collection period information included in the relative sharing vehicle information and (ii) the relative distance.

5. A navigation terminal for sharing a location of a vehicle, comprising:
a positioning information acquiring unit, implemented using one or more computing devices, configured to acquire positioning information about a mounted vehicle;
a data transceiver configured to:
upload, to a navigation server, vehicle information about the mounted vehicle at an update cycle, and
receive sharing vehicle information from the server to update the sharing vehicle information;
a location predicting unit, implemented using one or more computing device, configured to determine a location for each of sharing vehicles based on the sharing vehicle information including a speed constant at any point between a pre-update time and a post-update time related to the update cycle; and
a display configured to output the determined location and an electronic map including the locations of the sharing vehicles.

6. The navigation terminal of claim 5, wherein the location predicting unit comprises:
a relative distance predicting unit, implemented using one or more computing devices, configured to determine a relative distance for each of the sharing vehicles based on the sharing vehicle information at any time between a pre-update time and a post-update time related to the update cycle, and
a location calculating unit, implemented using one or more computing devices, configured to determine the locations of the sharing vehicles based on the relative distance and the location of the mounted vehicle.

7. The navigation terminal of claim 5, wherein the location predicting unit comprises:
a required time calculating unit, implemented using one or more computing devices, configured to determine a time required for transmission and reception based on an upload time stamp and a download time stamp for the positioning information included in the sharing vehicle information,
a relative distance predicting unit, implemented using one or more computing devices, configured to determine a relative distance for each of the sharing vehicles using the time required for transmission and reception and the sharing vehicle information, and
a location calculating unit, implemented using one or more computing devices, configured to determine the locations of the sharing vehicles based on the relative distance and the location of the mounted vehicle.

8. The navigation terminal of claim 5, wherein the data transceiver comprises:
a data receiver configured to receive the sharing vehicle information,
an update cycle determining unit, implemented using one or more computing devices, configured to determine an update cycle based on a collection cycle included in the sharing vehicle information, and
a data transmitter configured to transmit, to a navigation server, vehicle information including the update cycle.

9. The navigation terminal of claim 8, wherein the data transceiver further comprises:
an event determination unit, implemented using one or more computing devices, configured to, based on a travelling speed change exceeding a reference speed change, generate an event occurrence signal to be transmitted to the data transmitter to thereby cause the data transmitter to transmit event occurrence information to the server regardless of the update cycle.

10. The navigation terminal of claim 8, wherein the update cycle determining unit varies the update cycle depending on a map zoom level of the mounted vehicle.

11. A navigation system for sharing a location of a vehicle, comprising:
a navigation server configured to:
acquire relative sharing vehicle information about one or more vehicles associated with a preset sharing group,
determine a speed constant for predicting a relative distance for each vehicle based on the sharing vehicle information, and
transmitting sharing vehicle information including the speed constant, positioning information, and speed information; and
a navigation terminal configured to:
receive sharing vehicle information from the navigation server at a preset update cycle to update the sharing vehicle information,
determine a location of each of the sharing vehicles, and
display the location thereof in real time during a pre-update time and a post-update time related to the update cycle using the speed constant, positioning information, and speed information included in the sharing vehicle information.

12. The navigation system of claim 11, wherein the navigation server comprises:
a data receiver comprising:
a data collector configured to receive the sharing vehicle information from each vehicle at a predetermined collection cycle, and
a collection cycle determining unit, implemented using one or more computing devices, configured to determine a collection cycle for each vehicle based on a relative distance between one or more vehicles included in the sharing vehicle information collected by the data collector.

13. The navigation system of claim 12, wherein the navigation server comprises:
a speed constant estimating unit, implemented using one or more computing devices, and comprising:
a relative distance determination unit, implemented using one or more computing devices, configured to determine a relative distance of each vehicle to the one or more vehicles based on the sharing vehicle information; and
an estimating unit, implemented using one or more computing devices, configured to determine the speed constant using a speed constant estimation model based on the determined relative distance and location information.

14. The navigation system of claim 13, wherein the speed constant estimation model of the data receiver determines the speed constant using (i) at least one of the positioning information, speed information, travelling direction information, traffic information on a route, or collection cycle information included in the sharing vehicle information and (ii) the relative distance.

15. The navigation system of claim 11, wherein the navigation terminal comprises:
a positioning information acquiring unit, implemented using one or more computing devices, configured to acquire positioning information about a mounted vehicle;
a data transceiver configured to:
upload vehicle information about the mounted vehicle to a navigation server at an update cycle, and
receive sharing vehicle information from the server to update the sharing vehicle information;
a location predicting unit, implemented using one or more computing devices, configured to determine a location of each of the sharing vehicles at any point between a pre-update time and a post-update time related to the update cycle, based on the sharing vehicle information including a speed constant; and
a display configured to output the determined location and an electronic map including the locations of the sharing vehicles in real time.

16. The navigation system of claim 15, wherein the location predicting unit comprises:
a relative distance predicting unit, implemented using one or more computing devices, configured to determine a relative distance for each of the one or more vehicles based on the sharing vehicle information at any time between the pre-update time and the post-update time related to the update cycle, and
a location calculating unit, implemented using one or more computing devices, configured to determine the locations of the sharing vehicles based on the relative distance and the location of the mounted vehicle.

17. The navigation system of claim 15, wherein the location predicting unit comprises:
A required time calculating unit, implemented using one or more computing devices, configured to determine a time required for transmission and reception based on an upload time stamp and a download time stamp for the positioning information included in the sharing vehicle information;
a relative distance predicting unit, implemented using one or more computing devices, configured to determine a relative distance for each of the sharing vehicles using the time required for transmission and reception and the sharing vehicle information; and
a location calculating unit, implemented using one or more computing devices, configured to determine the locations of the sharing vehicles based on the relative distance and the location of the vehicle.

18. The navigation system of claim 15, wherein the data transceiver comprises:
a data receiver configured to receive the sharing vehicle information;
an update cycle determining unit, implemented using one or more computing devices, configured to determine an update cycle based on a collection cycle included in the sharing vehicle information; and
a data transmitter configured to transmit vehicle information including the update cycle to a navigation server.

19. The navigation system of claim 18, wherein the data transceiver further comprises:
an event determination unit, implemented using one or more computing devices, configured to, based on a travelling speed change exceeding a reference speed change, generate an event occurrence signal to be transmitted to the data transmitter to thereby cause the data transmitter to transmit event occurrence information to the server regardless of the update cycle.

20. The navigation system of claim 18, wherein the update cycle determining unit varies the update cycle depending on a map zoom level of the mounted vehicle.
